(19) United States
(12) Patent Application Publication
(10) Pub. No.: US 2007/0071459 A1
(43) Pub. Date: Mar. 29, 2007

(54) Image formation device for detecting unconfirmed quality consumable cartridge and consumable cartridge thereof

(75) Inventor: Hiroshi Nakazato, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/525,079

(22) Filed: Sep. 22, 2006

(30) Foreign Application Priority Data
Sep. 29, 2005 (JP) 2005-283196

(51) Int. Cl. G03G 15/00

(52) U.S. Cl. 399/12

(57) ABSTRACT

A consumable cartridge that is replacably attached to an image formation device, has a consumable storage section for replenishably storing a consumable, and a memory for unrewritably storing identification data and rewritably storing attribute data of the consumable cartridge. The memory can be read by the image formation device and rewritably stores a first error detection code generated by the identification data and attribute data. With this consumable cartridge, it can be detected that the identification data is regular data or not using the first error detection code.

### CROSS-REFERENCE TO RELATED APPLICATIONS

This application is based upon and claims the benefit of priority from the prior Japanese Patent Application No. 2005-283196, filed on Sep. 29, 2005, the entire contents of which are incorporated herein by reference.

### BACKGROUND OF THE INVENTION

1. Field of the Invention

The present invention relates to a consumable cartridge which can be removably attached to an image formation device, and more particularly to an image formation device for detecting an unconfirmed quality consumable cartridge and the consumable cartridge thereof.

2. Description of the Related Art

In equipment having an image formation device, such as an electro-photographic copier, electro-photographic printer, electro-photographic facsimile, electro-photographic composite machine, inkjet printer and inkjet composite machine, a consumable cartridge of toner or ink is removably attached, and when the consumable runs out, the consumable is replenished and the cartridge is used again. It is preferable that such a consumable cartridge is a quality assured cartridge where regular toner or ink, of which quality is assured, is filled. Toner and ink influence the mechanical structure, such as the cartridge and photo-sensitive drum to which toner attaches, so if toner and ink made of a material other than regular toner and ink are filled, it causes a failure of the cartridge and print engine. Therefore it has been proposed that an unconfirmed quality consumable cartridge, of which quality is not assured, is detected, and a predetermined warning is output or image formation itself is disabled. Examples are disclosed in Japanese Patent Publication No. H4-500482, Japanese Patent Application Laid-Open No. 2001-125377 and Japanese Patent Application Laid-Open No. 2000-19803.

According to these documents, an IC tag of a non-volatile memory is provided in a consumable cartridge, operation data, such as residual amount data and accumulated operation time data, of the consumable is stored via a memory of this IC tag, and it is checked whether this is an unconfirmed quality cartridge or not by analyzing this data.

However, if a third party vendor collects the used cartridge, replenishes or refills an unconfirmed quality consumable and copies all the data in the tag memory of the quality assured consumable cartridge to a tag memory of the recycled cartridge, it is impossible to detect that the quality of the recycled cartridge is not confirmed.

### SUMMARY

With the foregoing in view, it is an object of the present invention to provide an image formation device which can detect an unconfirmed quality consumable cartridge of which quality is not assured, and the consumable cartridge thereof.

To achieve the above object, a first aspect of the present invention is a consumable cartridge that is replacably attached to an image formation device, having a consumable storage section for replenishably storing a consumable, and a memory for unrewritably storing identification data and rewritably storing attribute data of the consumable cartridge, wherein the memory can be read by the image formation device and rewritably stores a first error detection code generated by the identification data and attribute data.

With this consumable cartridge, it can be detected that the identification data is regular data or not using the first error detection code.

According to a preferred mode of the first aspect, the memory rewritably stores a second error detection code generated from the attribute data.

According to this preferred mode, an unconfirmed quality cartridge can be detected separately from an error of the attribute data, using the first error detection code and the second error detection code.

To achieve the above object, a second aspect of the present invention is an image formation device for detecting whether a consumable cartridge that is replacably attached is an unconfirmed quality cartridge or not, wherein the consumable cartridge has a consumable storage section for replenishably storing a consumable, and a memory for unrewritably storing identification data and rewritably storing attribute data of the consumable cartridge, the memory can be read by the image formation device, and rewritably stores a first error detection code generated by the identification data and attribute data, and the image formation device further has a control unit for reading data in the memory and detecting an unconfirmed quality cartridge based on the first error detection code.

According to the preferred mode of the second aspect, the memory rewritably stores a second error detection code generated from the attribute data, and the control unit detects whether the identification code or attribute data has an error or not based on the first error detection code, detects whether the attribute data has an error or not based on the second error detection code, and detects an unconfirmed quality cartridge when an error is detected based on the first error detection code, and an error is not detected based on the second error detection code.

Even if a third party vendor copies all or a part of the data in the tag memory of a quality assured product to the tag memory of a collected product, the unconfirmed quality can be detected.

### BRIEF DESCRIPTION OF THE DRAWINGS

FIG. 1 is a perspective view depicting the image formation device according to the present embodiment;

FIG. 2 is a side view depicting the image formation device viewed in the X direction in FIG. 1;

FIG. 3 is a diagram depicting a configuration of the control unit and a part of the print engine according to the present embodiment;

FIG. 4 shows data in the tag memories of a conventional collected toner cartridge and recycled toner cartridge by a regular vendor;

FIG. 5 shows data in the tag memories of a collected toner cartridge and recycled toner cartridge by a regular vendor according to the first embodiment;

FIG. 6 shows data in the tag memories of a collected toner cartridge and recycled toner cartridge by a third party vendor according to the first embodiment;

FIG. 7 is a flow chart depicting the unconfirmed quality toner cartridge detection processing by the control unit according to the first embodiment;

FIG. 8 shows data in the tag memories of the collected toner cartridge and recycled toner cartridge by a regular vendor according to the second embodiment;

FIG. 9 shows data in the tag memories of the collected toner cartridge and recycled toner cartridge by a third party vendor according to the second embodiment;

FIG. 10 is a flow chart depicting the unconfirmed quality toner cartridge detection processing by the control unit according to the second embodiment; and

FIG. 11 shows the transition of the unconfirmed quality cartridge according to the third embodiment.

### DESCRIPTION OF THE PREFERRED EMBODIMENTS

Embodiments of the present invention will now be described with reference to the drawings. The technical scope of the present invention, however, is not limited to these embodiments, but reaches the content of the Claims and equivalents thereof.

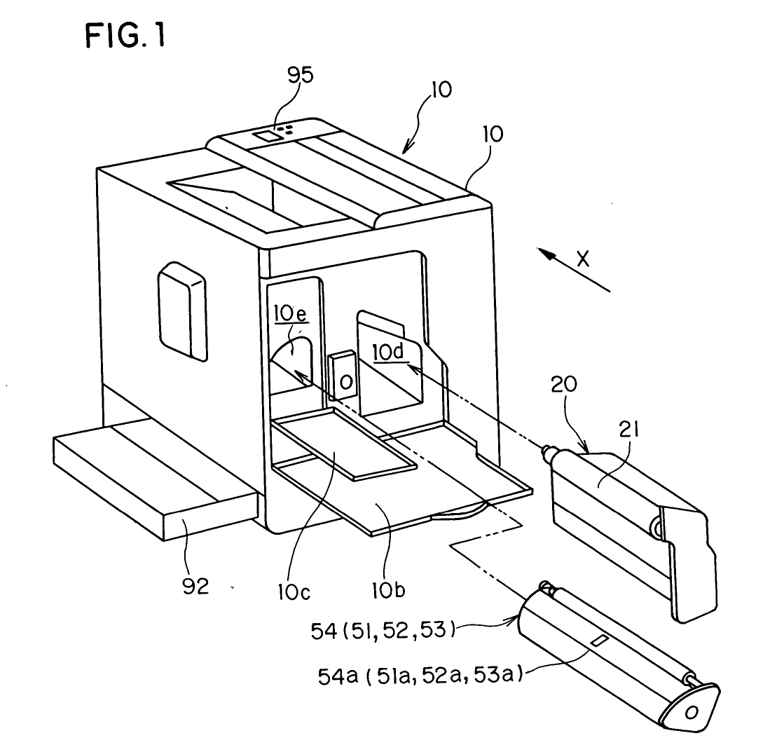

FIG. 1 is a perspective view depicting the image formation device according to the present embodiment. In the image formation device 10, that is a printer, for example, a display operation panel 95 is provided on the surface of the main body 10a, a paper feed cartridge 92 is provided on a side face, open/close covers 10b and 10c are provided on another side face, a photo-sensitive unit 20 is attached/removed through the opening 10d which can be seen when the open/close cover 10b is opened, and toner cartridges 51-54, which are development units, are attached/removed through the opening 10e which can be seen when the open/close cover 10c is opened. The toner cartridges 51-54 are consumable cartridges for containing toner, which is consumable, where the tag memories 51a-54a for storing operation data, such as residual amount of toner and the operation time of the cartridge, are provided.

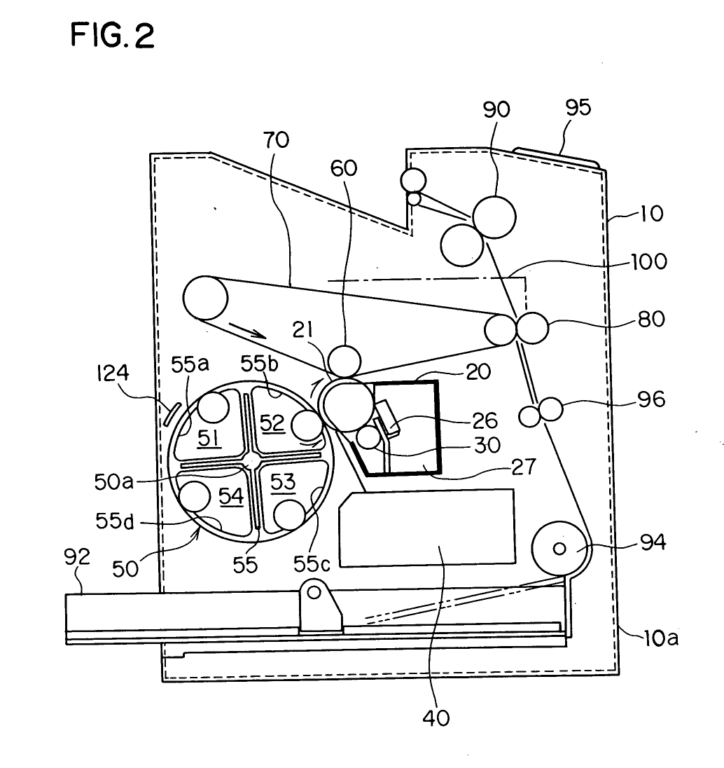

FIG. 2 is a side view depicting the image formation device viewed in the X direction in FIG. 1. The main body 10a houses the photo-sensitive unit 20 having a photo-sensitive drum 21, a charge unit 30 for charging the photo-sensitive material, a cleaning blade for toner 26, and a disposed toner storage section 27, an exposure unit 40 for forming a latent image by irradiating laser onto the photo-sensitive drum 21, a development unit 50 for supplying cyan, magenta, yellow and black toner onto the latent image on the photo-sensitive drum 21 and developing the image, a primary transfer unit 60 for transferring the toner image developed on the photo-sensitive drum 21 to an intermediate transfer medium 70, a secondary transfer unit 80 for transferring the toner image on the intermediate transfer medium 70 to print paper, paper feed rollers 94 and 96 and a control unit 100.

In the development unit 50, toner cartridges 51-54 containing the above mentioned four colors of toner are removably attached to a development rotary 55, and toner is supplied from each toner cartridge to the photo-sensitive drum 21 by rotating the development rotary 55 around the center 50a. Each toner cartridge 51-54 is attached to the attachment sections 55a, 55b, 55c and 55d of the development unit 50. And a memory access unit 124 is installed near the development unit 50, and performs the read and write access operation to the tag memories 51a-54a of each toner cartridge 51-54.

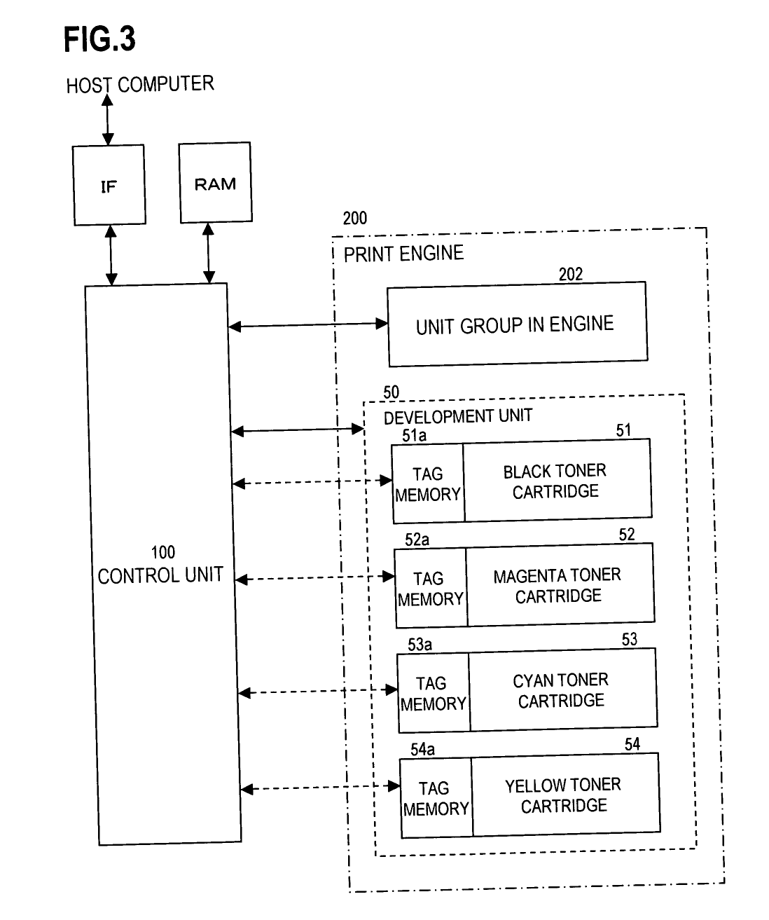

FIG. 3 is a diagram depicting a configuration of the control unit and a part of the print engine of the present embodiment. The control unit 100 receives print data from the host computer, scanner unit or fax unit via the interface IF, and performs predetermined image processing using an image memory RAM. Also the control unit 100 supplies the processed image formation data to the print engine 200, and controls image formation corresponding to the print data by controlling the unit group 202 and development unit 50 in the print engine 20.

Each toner cartridge 51-54 to be attached to the development unit 50 has a storing section for replenishably storing toner, which is a consumable, and has tag memories 51a-54a for storing operation data, such as the residual amount of toner and accumulated operation time of the cartridge. The control unit 100 reads data from the tag memory, performs print control corresponding to the operation data, and updates the operation data, such as residual amount of toner and accumulated operation time of the cartridge to the latest information after printing. The control unit 100 also reads data from the tag memory, checks whether the toner cartridge is a quality assured product or an unconfirmed quality product, and outputs a warning on the operation display panel 95 if necessary, or disables the print operation in a worse case scenario.

Now a method of detecting an unconfirmed quality toner cartridge by the control unit 100 will be described.

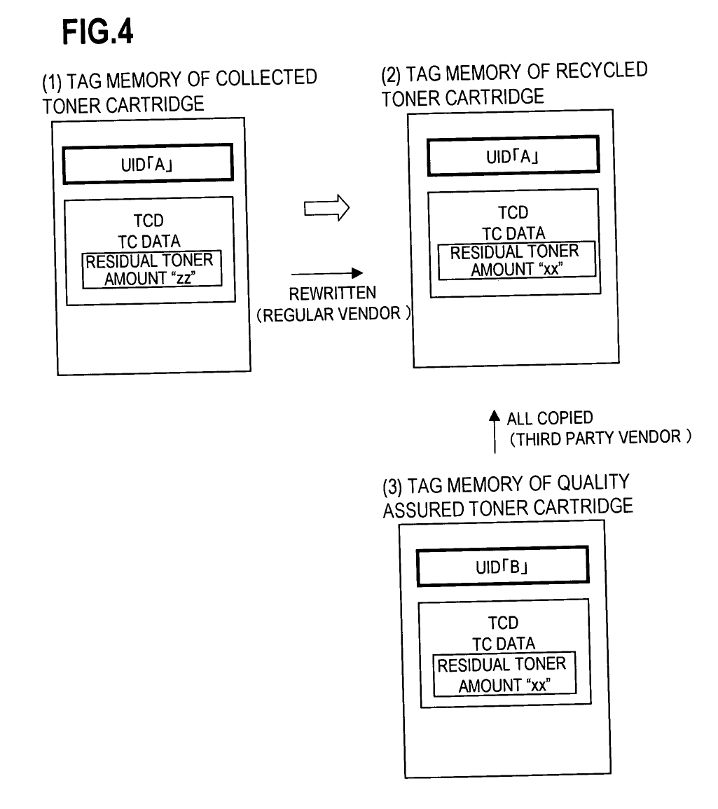

FIG. 4 shows conventional data in the tag memories of a collected toner cartridge and a recycled toner cartridge by a regular vendor. Here as the tag memory in the collected toner cartridge in (1) shows, the tag memory is a non-volatile memory, such as a flash memory or ferroelectric memory, where the identification data UID for uniquely identifying the memory, such as serial data, is unrewritably stored. And the attribute data TCD of the toner cartridge is written in the storage area of this tag memory. The attribute data TCD includes the identification data, such as serial number of the cartridge, and operation data, such as residual amount data of toner, which is a consumable, and accumulated operation time data of the cartridge.

A regular vendor replenishes toner in the collected toner cartridge in (1), and rewrites the attribute data TCD in the tag memory. Specifically, the regular vendor rewrites the operation data, such as residual toner amount data and accumulated operation time data, with the data of the new product, and distributes it to market as the recycled cartridge in (2). A third party vendor, on the other hand, replenishes the toner of the collected cartridge, copies all the data in the tag memory of the quality assured toner cartridge shown in (3) to the tag memory of the collected cartridge, and distributes it to market as the recycled cartridge in (2). In the attribute data TCD in the tag memory of the quality assured product in (3), operation data is stored as a new product data, by copying all data so the judgment result of “unusable” can be avoided in the operation data check step when the cartridge is attached to the image formation device.

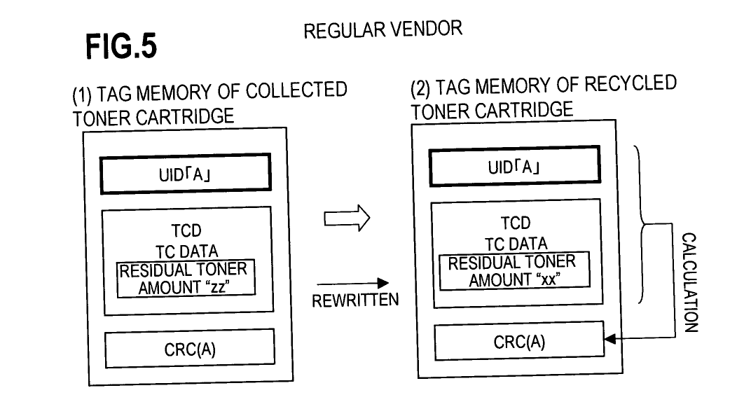

FIG. 5 shows data in the tag memories of the collected toner cartridge and recycled toner cartridge by a regular vendor according to the first embodiment. In the present embodiment, as the tag memory of the collected toner cartridge in (1) shows, an error detection code CRC, computed from the identification data UID which are unrewritable and attribute data TCD of the toner cartridge in the memory, is stored. For this error detection code CRC, a CRC (Cyclic Redundancy Check) code, for example, is used. By using a CRC code, the error detection capability can be increased. An error detection code, other than CRC code, such as a parity check code, may be used. When the cartridge is attached to the image formation device and an image is formed, operation data, such as residual toner amount, in the attribute data TCD is updated as the toner is used, and follow to this data update, the error detection code CRC is also recomputed and updated.

A regular vendor collects this toner cartridge, replenishes toner and rewrites the operation data, such as residual toner amount data, out of the attribute data TCD, and computes and rewrites the error detection code CRC accordingly. And distributes it to market as the recycled toner cartridge in (2). When the recycled cartridge is attached to the image formation device, the control unit of the image formation device reads the data in the tag memory, computes the error detection code from the identification data UID and attribute data TCD, compares it with the stored code CRC, and uses this cartridge as a quality assured product without any error in the attribute data if these codes match. If there is no match, the control unit assumes that the cartridge is an unconfirmed quality product distributed by a third party vendor or the attribute data has an error, and rejects the use of the toner cartridge or outputs a warning.

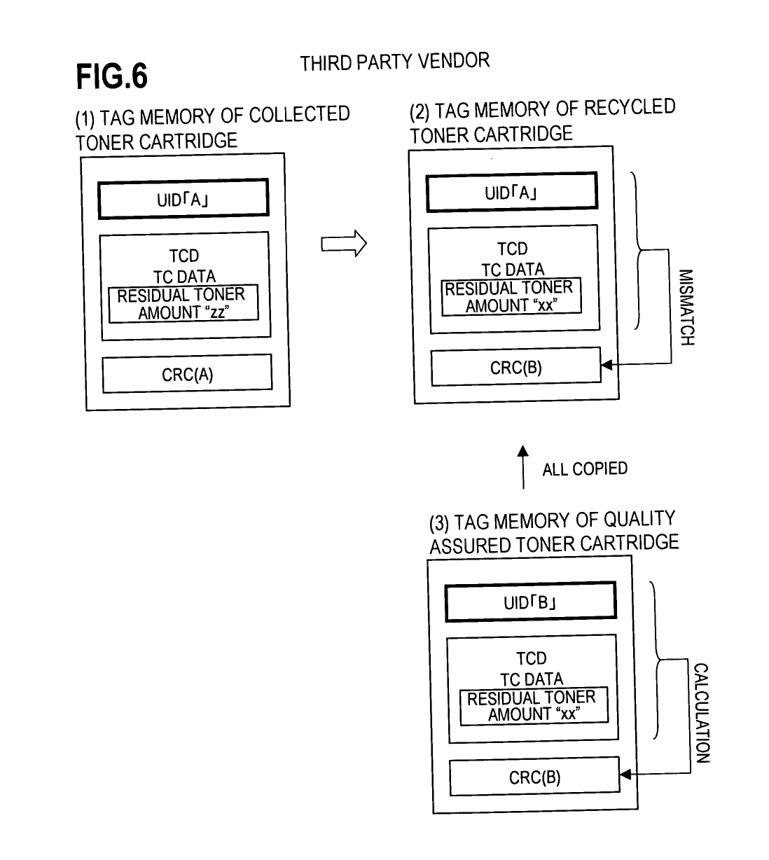

FIG. 6 shows data in the tag memories of a collected toner cartridge and recycled toner cartridge by a third party vendor according to the first embodiment. As described in FIG. 4, the third party vendor copies all data in the tag memory of the quality assured product in (3) in the tag memory of the collected toner cartridge in (1). The identification code UID, which is unrewritably stored, however, cannot be rewritten. In the quality assured product in (3), the error detection code CRC (B) is computed by the identification data UID “B” and attribute data TCD thereof. Therefore, in the case of the recycled tag memory in (2), to which all data of the tag memory of the quality assured product in (3) is copied, the error detection code computed by the identification data UID “A” and attribute data TCD does not match with the stored error detection code CRC (B), therefore the image formation device assumes that this cartridge is an unconfirmed quality product distributed by a third party vendor, or the attribute data has an error, and rejects the use of the toner cartridge or outputs a warning.

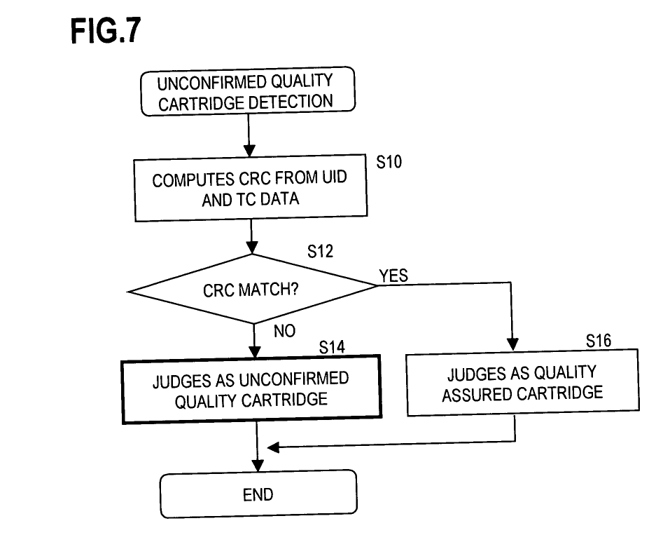

FIG. 7 is a flow chart depicting the unconfirmed quality toner cartridge detection processing by the control unit according to the first embodiment. When a new toner cartridge is attached, the control unit reads the data in the tag memory, and computes an error detection code CRC from the identification code UID and attribute data (S10). And compares the computed error detection code and error detection code read from the tag memory (S12). If the codes match, the control unit judges that the cartridge is a quality assured cartridge and the attribute data has no error, and enables the use of the toner cartridge (S16). If the codes mismatch, the control unit judges that the cartridge is an unconfirmed quality cartridge distributed by a third party vendor, and outputs a warning that the toner cartridge is an unconfirmed quality product, or disables use (S14). If the codes mismatch, it is also possible that the attribute data has an error, so a message to notify “unconfirmed quality cartridge or attribute data has an error” may be included in the warning to be output.

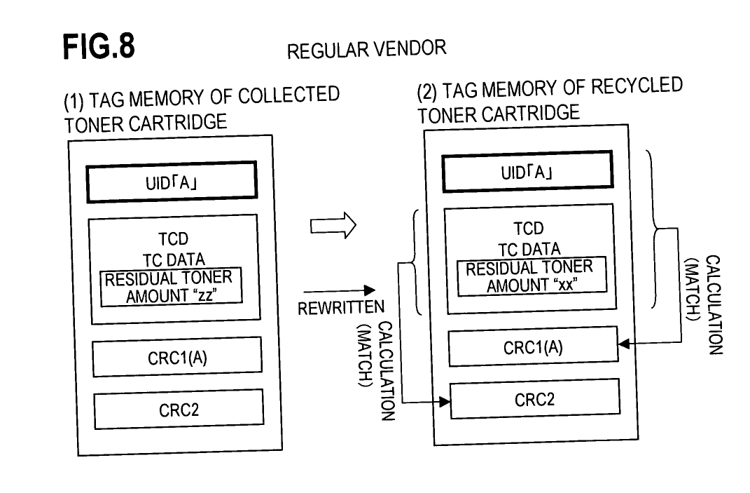

FIG. 8 shows the data in the tag memories of the collected toner cartridge and recycled toner cartridge by a regular vendor according to the second embodiment. In the first embodiment, if the error detection codes do not match, it cannot be identified whether the cartridge is an unconfirmed quality cartridge or attribute data has an error.

In the second embodiment, an unconfirmed quality cartridge and an attribute data error can be separately detected.

In the second embodiment, as the tag memory of the collected toner cartridge in (1) shows, the two error detection codes CRC1 and CRC2 are stored in the tag memory. The first error detection code CRC1 is computed from the identification data UID and attribute data TCD, just like the first embodiment.

The second error detection code CRC2 is computed from the attribute data TCD. The regular vendor replenishes toner to the collected cartridge in (1), rewrites the operation data, such as residual toner amount data and accumulated operation time data, of the attribute data TCD, and computes and writes the first error detection code CRC1 and the second error detection code CRC2, and distributes it to market as the recycled cartridge in (2).

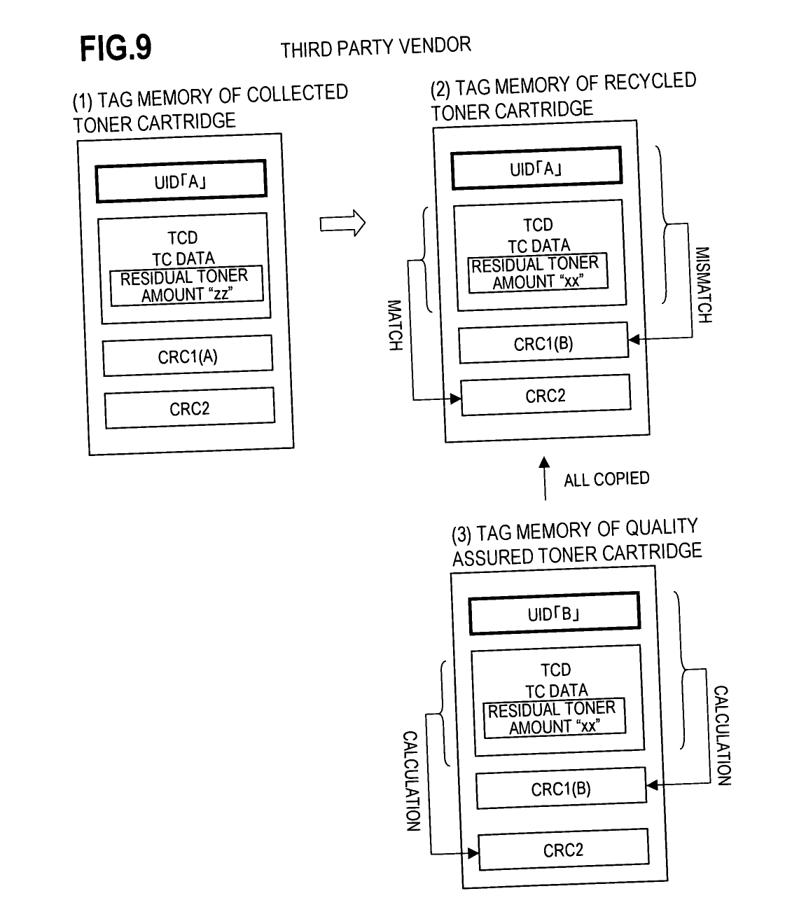

FIG. 9 shows the data in the tag memories of the collected toner cartridge and recycled toner cartridge by a third party vendor according to the second embodiment. The third party vendor copies all data in the tag memory of the quality assured cartridge in (3) to the tag memory of the collected cartridge in (1), and distributes it to market as a recycled cartridge in (2). The unrewritable identification data UID, however, cannot be overwritten. When this recycled cartridge is attached to the image formation device, the control unit checks the presence of an error using the first and second error detection codes CRC1 and CRC2, and whether this cartridge is a proper cartridge, whether this cartridge is an unconfirmed quality cartridge, and whether the attribute data TCD has an error, are detected separately. Even if it is detected that the attribute data has an error, however, whether the cartridge is a quality assured product or an unconfirmed quality product cannot be distinguished.

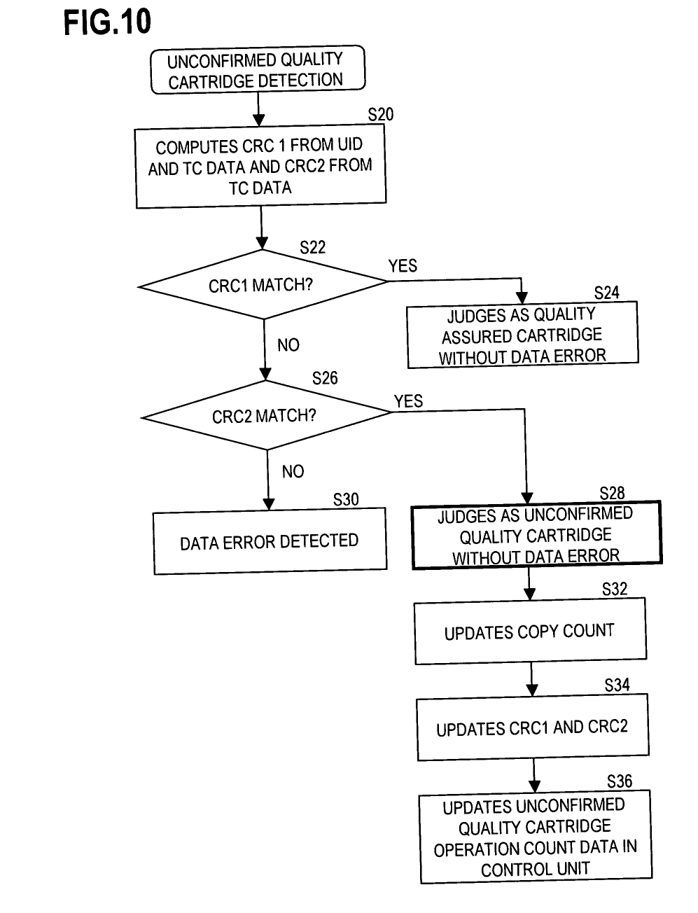

FIG. 10 is a flow chart depicting the unconfirmed quality toner cartridge detection processing by the control unit according to the second embodiment. When a new toner cartridge is attached, the control unit reads the data in the tag memory, computes the first error detection code CRC1 from the identification code UID and attribute data TCD, and also computes the second error detection code CRC2 from the attribute data TCD (S20). And checks whether the computed first error detection code CRC1 matches with the first error detection code stored in the tag memory (S22), and if there is a match, the control unit judges that the cartridge is a quality assured cartridge, and the attribute data TCD has no error (S24).

If the first error detection codes do not match in step S22, the control unit checks whether the computed second error detection code CRC2 matches with the second error detection code stored in the tag memory (S26), and if there is a match, the control unit judges that the attribute data TCD has no error, but this cartridge is an unconfirmed quality cartridge (S28). In other words, in the case when the first error detection codes CRC1 mismatch but the second error detection codes CRC2 match, it is certain that the attribute data TCD has no error since the second error detection codes CRC2 match, so if the first error detection codes CRC1 mismatch, it can be judged that the first error detection code CRC1 was generated from the identification data “B” in the tag memory of another cartridge. If the second error detection codes CRC2 mismatch, the control unit judges that the attribute data TCD has an error (S30). In other words, if the second error detection codes CRC2 mismatch, it is at least certain that the attribute data TCD has an error. But the first error detection codes CRC1 also mismatch, so it cannot be judged whether the identification data UID is identification data in the tag memory of another cartridge or not, even if the error of the attribute data TCD can be judged.

It would be possible to store the third error detection code computed only from the identification data UID, but in that case, if the third error detection codes mismatch, it cannot be judged whether the identification data UID has an error, or the third error detection code was computed from the identification data in the tag memory of another cartridge.

In this way, according to the second embodiment, it can be judged that the cartridge is an unconfirmed quality cartridge and that the attribute data has no error, so the case when the attribute data has an error can be detected separately. Steps S32-S36 in FIG. 10 are the steps of the third embodiment.

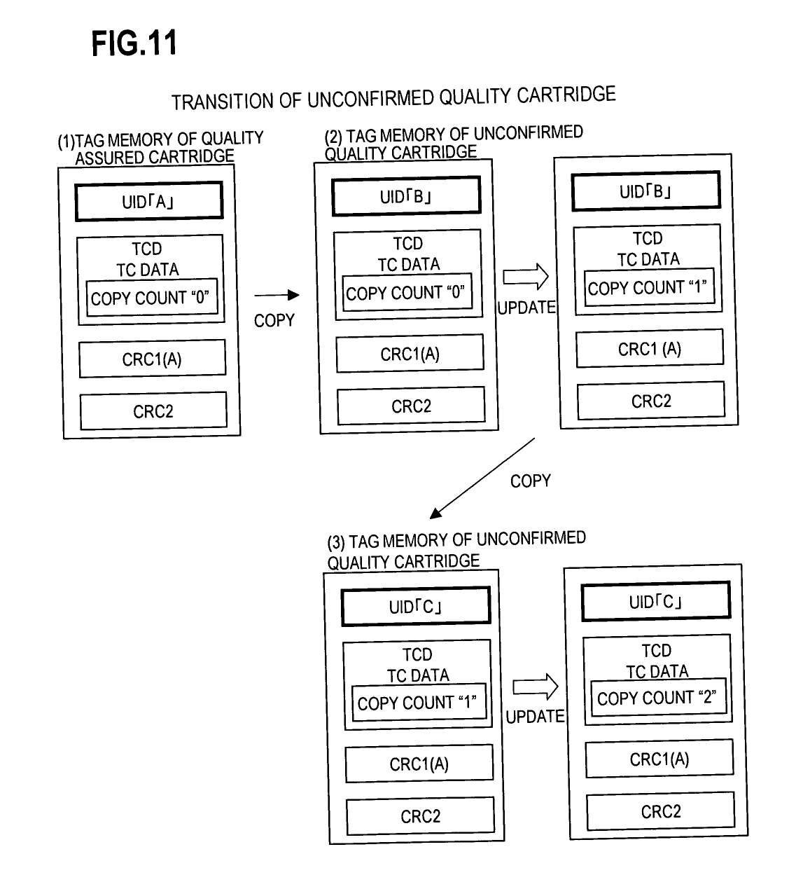

FIG. 11 is a diagram depicting the transition of the unconfirmed quality cartridge in the third embodiment. The third party vendor copies all data in the tag memory of the quality assured product in (1), and distributes it to market as a recycled cartridge. As a result, this cartridge becomes an unconfirmed quality cartridge in (2). When this toner cartridge is first attached, the control unit of the image formation device detects that this cartridge is an unconfirmed quality cartridge from the first and second error detection codes CRC1 and CRC2 in the tag memory of this unconfirmed quality cartridge, and increments the copy count data stored in the attribute data TCD by 1 (S32 in FIG. 10). Along with this update of the attribute data TCD, the control unit computes the first and second error detection codes CRC1 and CRC2, and updates them in memory (S36 in FIG. 10). Then the control unit increments the unconfirmed quality cartridge operation count data by 1 (S36 in FIG. 10).

It is assumed that the third party vendor handles the unconfirmed quality cartridge shown in FIG. 11 (2) as a quality assured product, and copies all data in (2) in the memory to the tag memory of another collected cartridge of (3). In other words, it is assumed that a second generation unconfirmed quality cartridge is generated. In this case as well, the control unit of the image formation device detects that this cartridge is an unconfirmed quality cartridge when the cartridge is first attached (S28 in FIG. 10). And the control unit increments the copy amount in the attribute data TCD by 1 (S32 in FIG. 10), computes new first and second error detection codes CRC1 and CRC2, and writes them to the tag memory (S34 in FIG. 10). The control unit also updates the illegal cartridge operation count data in the memory of the control unit (S36 in FIG. 10).

In this way, according to the third embodiment, when an unconfirmed quality cartridge is detected, the control unit of the image formation device first updates (+1) the copy count data stored in the tag memory, then updates (+1) the unconfirmed quality cartridge operation count data stored in the memory of the control unit. The copy count data in the tag memory indicates the number of generation of an unconfirmed quality cartridge, and by knowing this copy count data, the distributed range of unconfirmed quality cartridges can be recognized.

The unconfirmed quality cartridge operation count data in the control unit indicates how many times the image formation device used an unconfirmed quality cartridge. Using this data, a business model of discounting maintenance charges when the operation count of an unconfirmed quality cartridge is low, for example, can be used. In both cases, an unconfirmed quality cartridge and attribute data error can be detected separately by storing two error detection codes in the tag memory, just like the case of the second embodiment, so in the third embodiment, the generation count data of an unconfirmed quality cartridge and unconfirmed quality cartridge operation count data of an image formation device can be updated when an unconfirmed quality cartridge or attribute data error is detected, and this data can be utilized in the future.

In the above embodiments, the first error detection code is created using the identification data of the memory which is unrewritably stored.

However, this is not limited to the identification data of the memory, and if the identification data of the cartridge can be unrewritably stored, the first error detection code can also be generated by this identification data. The non-volatile memory has a function to make the storage area write protected and unrewritable, so as to prevent rewriting the data. If this function is used, an arbitrary identification data can be unrewritably stored.

As described above, according to the present embodiment, even if a third party vendor copies all or a part of the data in the tag memory of a quality assured product to a tag memory of a collected toner cartridge, this status can be detected. By detecting an unconfirmed quality cartridge, the possibility of a problem with a print engine, which may be caused by a consumable of which quality is unconfirmed, can be warned in advance, or printing can be disabled in a worse case scenario.

What is claimed is:

1. A consumable cartridge that is replacably attached to an image formation device, comprising:
a consumable storage section for replenishably storing a consumable; and
a memory for unrewritably storing identification data and rewritably storing attribute data of said consumable cartridge, wherein
said memory can be read by said image formation device, and rewritably stores a first error detection code generated by said identification data and attribute data.

2. The consumable cartridge according to claim 1, wherein said memory rewritably stores a second error detection code generated from said attribute data.

3. The consumable cartridge according to claim 2, wherein when an error is detected by said first error detection code and an error is not detected by said second error detection code, copy count data is written in said memory as said attribute data.

4. The consumable cartridge according to any of claim 1, wherein said attribute data includes operation data of said consumable, and said operation data is updated when the consumable is used.

5. The consumable cartridge according to any of claim 1, wherein said identification data is an identification data of said memory or consumable cartridge.

6. The consumable cartridge according to any of claim 1, wherein said identification data from which said first error detection code is generated is an identification data of said memory or consumable cartridge, or an identification data of another memory or consumable cartridge.

7. An image formation device for detecting whether a consumable cartridge that is replacably attached is an unconfirmed quality cartridge or not, wherein
said consumable cartridge comprises a consumable storage section for replenishably storing a consumable, and a memory for unrewritably storing identification data and rewritably storing attribute data of said consumable cartridge, and
said memory can be read by said image formation device, and rewritably stores a first error detection code generated by said identification data and attribute data,
the image formation device further comprising:
a control unit which reads data in said memory, and detects an unconfirmed quality cartridge based on said first error detection code.

8. The image formation device according to claim 7, wherein
said memory rewritably stores a second error detection code generated from said attribute data, and
said control unit detects whether said identification code or attribute data has an error or not based on said first error detection code, detects whether said attribute data has an error or not based on said second error detection code, and detects an unconfirmed quality cartridge when an error is detected based on said first error detection code and an error is not detected based on said second error detection code.

9. The image formation device according to claim 8, wherein when an error is detected based on said first error detection code and an error is not detected based on said second error detection code, said control unit writes copy count data in a storage area of said attribute data.

10. The image formation device according to claim 8, wherein said control unit stores data of unconfirmed quality cartridge operation count, and updates said data of unconfirmed quality cartridge operation count when said unconfirmed quality cartridge is detected.
